(19) United States
(12) Patent Application Publication
(10) Pub. No.: US 2009/0167880 A1
(43) Pub. Date: Jul. 2, 2009

(54) Method for obtaining sharp pictures

(76) Inventors: Wan-Chun Yang, Sijhih City (TW); Chi-Jung Weng, Rende Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/071,610

(22) Filed: Feb. 25, 2008

(30) Foreign Application Priority Data
Dec. 26, 2007 (TW) 96150308

(51) Int. Cl. H04N 5/225; G03B 15/03

(52) U.S. Cl. 348/218.1; 396/165; 348/E05.024

(57) ABSTRACT

A method of obtaining sharp pictures by calibrating blurred picture generated due to vibration while a photograph is taken is disclosed. First, a first picture is captured. The flash is judged to see if it is switched on. If the first picture is captured when the flash is switched off, then a second picture is captured when the flash is switched on. The first picture is calibrated based on the second picture, and stored after calibration.

### BACKGROUND OF THE INVENTION

1. Field of the Invention

The invention generally relates to a method for obtaining sharp pictures, and more particularly to a method for obtaining sharp pictures by calibrating blurred pictures captured due to vibration during taking a photograph.

2. Description of the Related Art

A conventional digital picture capturing device such as camera provides pictures of high-quality sharp frames and has been persuading more perfectly defined details. In order to reduce the vibration while taking a photograph, optical correction system or software calibration scheme has been proposed to solve the problem.

The optical correction system utilizes a vibration sensor to detect the vibrating level of the camera and corrects the position of the lens or the light sensing element so as to offset the vibration of the camera body. The software calibration scheme utilizes a vibration sensor to record all vibrating traces of the camera, and performs analysis, restoration and supplement on the pictures according to a picture processing calculation.

Usually, blurred pictures are generated when the exposure time exceeds the safe-mode exposure time and the long exposure time increases the possibility of vibration during exposure, which can lead to a blurred picture. A long exposure time is required when the environment is dark and no artificial light source is provided, for example indoors or at nightfall. The exposure time is prolonged in order to increase the amount of incoming light. At safe-mode, 1/30- 1/60 of shutter speed of shutter speed is enough to obtain a sharp picture. Increasing the receptor sensitivity is an alternative to increase the brightness of the environment to obtain a sharp picture. Even though an increased receptor sensitivity can reduce the problem of long exposure time, the captured picture may still be blurred due to involuntary camera movement. Therefore, there is a need of a camera with an improved anti-vibration function.

### SUMMARY OF THE INVENTION

It is an object of the invention to provide a method of obtaining sharp pictures by calibrating blurred pictures generated due to vibration while a photograph is taken. Immediately after a first picture has been captured, a second picture is captured with flash. The second picture captured with flash has short exposure time and sharp details, and thus can be used to calibrate the first picture to obtain a calibrated sharp picture.

It is an object of the invention to provide a method of obtaining sharp pictures by calibrating blurred pictures generated due to vibration while a photograph is taken. Immediately after a first picture has been captured, a second picture is captured with flash. The second picture captured with flash has short exposure time and sharp details, and thus can be used to calibrate the first picture to obtain a calibrated sharp picture.

It is another object of the invention to provide a method which calibrates blurred pictures generated due to vibration while a photograph is taken, so as to obtain sharp pictures.

In order to achieve the above and other objectives, the method of obtaining sharp pictures by calibrating blurred pictures generated due to vibration while a photograph is taken uses a camera to take pictures. The camera includes an input module, a flash module, a picture capturing module, a register, a memory module and a processing unit. The input module is used to receive an external actuation for triggering the camera to generate a picture capturing signal. The flash module includes a camera flash to supplement the light intensity in the environment. The picture capturing module captures digital pictures. The register is coupled with the picture capturing module to temporarily store the pictures captured by the picture capturing module. The memory module stores the digital pictures. The processing unit is coupled with those above modules to control their operations.

The method of obtaining sharp pictures includes steps of receiving a picture capturing signal which is generated when the user triggers the camera; judging if the flash is switched on; if the flash is switched on, then the currently captured picture is stored; if the flash is switched off, then capturing a first picture which is then temporarily stored to the register; switching on the flash, capturing a second picture which is then temporarily stored to the register; switching off the flash; calibrating the first picture based on the second picture, and storing the calibrated first picture to the memory module.

The invention further provides a method of obtaining sharp pictures by calibrating blurred pictures generated due to vibration while a photograph is taken uses a camera to take pictures. The camera used to implement the method of obtaining sharp in the embodiment below is the same as the above. The method includes steps of receiving a picture capturing signal which is generated when the user triggers the camera; capturing a first picture by the picture capturing module; judging if the flash is switched on; if the flash is switched on, then storing the first picture to the memory module as an output picture; otherwise switching on the flash, capturing a second picture which is then temporarily stored to the register; switching off the flash; calibrating the first picture based on the second picture, and storing the calibrated first picture to the memory module.

In this embodiment, the camera provides a picture processing for calibrating the first picture based on the second picture. The picture processing includes steps of comparing sharp lines of the first picture with that of the second picture to define new sharp lines for the first picture; removing blurred parts around the new sharp lines of the first picture to obtain a calibrated first picture.

The invention further provides a picture calibration system for the camera. The picture calibration system includes a processing unit, a picture capturing module, a register, a flash module and a memory module. The picture capturing module captures at least one digital picture. The flash module includes a camera flash to supplement the light intensity in the environment. The register is coupled with the picture capturing module to temporarily store the captured picture. The memory module stores the picture. The processing unit is coupled with the picture capturing module, the flash module, the register and the memory module to control their operations. The processing unit determines the number of the pictures to capture and calibrate according to the status of the flash module

In one embodiment of the invention, the camera further includes an input module coupled with the processing unit to input an external actuation for triggering the picture calibration system to generate a picture capturing signal.

In another embodiment, the camera is, for example, mobile phone, digital camera, digital video camera or other appliances suitable for the method of the invention.

To provide a further understanding of the invention, the following detailed description illustrates embodiments and examples of the invention, this detailed description being provided only for illustration of the invention.

### BRIEF DESCRIPTION OF THE DRAWINGS

FIG. 1 is a schematic view of a digital camera according to one embodiment of the invention.

FIG. 2 is a flow chart of a method of obtaining sharp pictures by calibrating blurred pictures captured due to vibration while a photograph is taken according to one embodiment of the invention.

FIG. 3A and FIG. 3B are schematic views of picture calibration according to one embodiment of the invention. FIG. 3A and FIG. 3B are schematic views of picture calibration according to one embodiment of the invention.

FIG. 4 is a flow chart of a method of capturing pictures with high sharpness according to another embodiment of the invention.

### DETAILED DESCRIPTION OF THE EMBODIMENTS

Wherever possible in the following description, like reference numerals will refer to like elements and parts unless otherwise illustrated.

A digital camera turns on its flash to supplement the light intensity in the environment. Therefore, capturing digital pictures under flash can be achieved by a shutter at safe mode. The short exposure time contributes to vibration reduction, makes the captured digital pictures sharper.

While a picture is captured without flash, anther picture is captured for substantially the same site and conditions as the previous picture. Since these two pictures are taken at quite short time interval, the later one can be used to calibrate the former one to produce a calibrated picture with better sharpness and less vibration.

The method of capturing pictures uses the flash function of the camera to sharpen the blurred pictures and therefore can be applied to any kind of digital cameras with flashes. However, it is well know for those skilled in the art that the camera further includes other implementing devices in addition to those forth set below. The invention is illustrated by exemplifying, but not limiting to, the embodiments below.

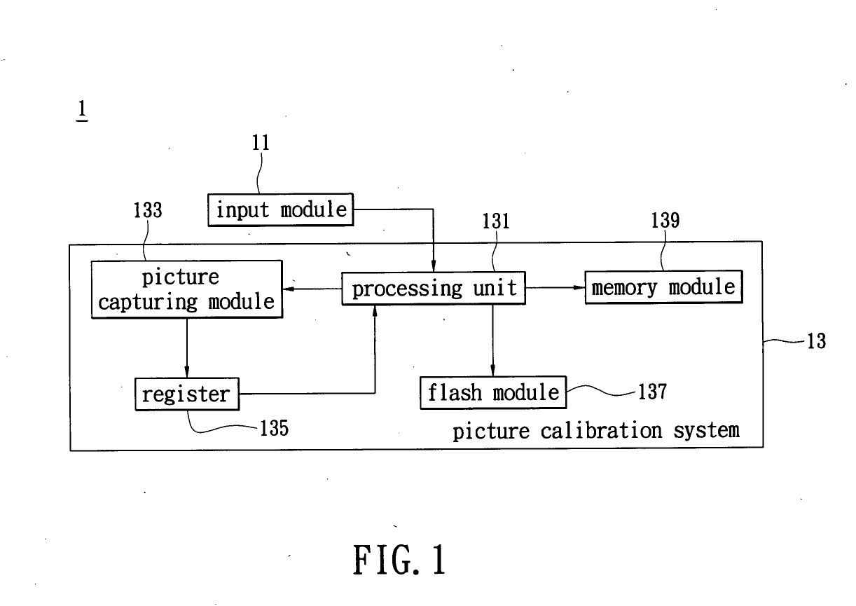

FIG. 1 is a schematic view of a digital camera according to one embodiment of the invention. As shown in FIG. 1, a digital camera 1 includes an input module 11 and a picture calibration system 13. The digital camera 1 can be, for example, a mobile phone, a digital camera, a digital video camera or any appliances which can be perform the method of capturing pictures according to the invention. The picture calibration system 13 includes a processing unit 131, a picture capturing module 133, a register 135, a flash module 137 and a memory module 139. The processing unit 131 is coupled respectively with the picture capturing module 133, the register 135, the flash module 137 and the memory module 139.

The input module 11 is used to input an external actuation to trigger the camera to generate an image capturing signal. Specifically, the input module 11 can be release button of the digital camera 1. The user presses down the release button to generate an actuating signal for controlling the processing unit 131 to output the picture capturing signal.

The flash module 137 includes at least a camera flash to increase the light intensity in the environment. The picture capturing module 133 is used to receive the picture capturing signal from the processing unit 131 to carry out the digital picture capturing process. The register 135 is coupled with the picture capturing module 133 and the processing unit 131, and used to temporarily store the digital picture from the picture capturing module 133 for subsequent access in the processing unit 131. The memory module 139 is used to store the digital pictures.

The processing unit 13 is used to, in addition to control the operations of the above modules, perform the picture processing on the digital pictures taken by the picture capturing module 133 so as to output a sharper picture after the calibration.

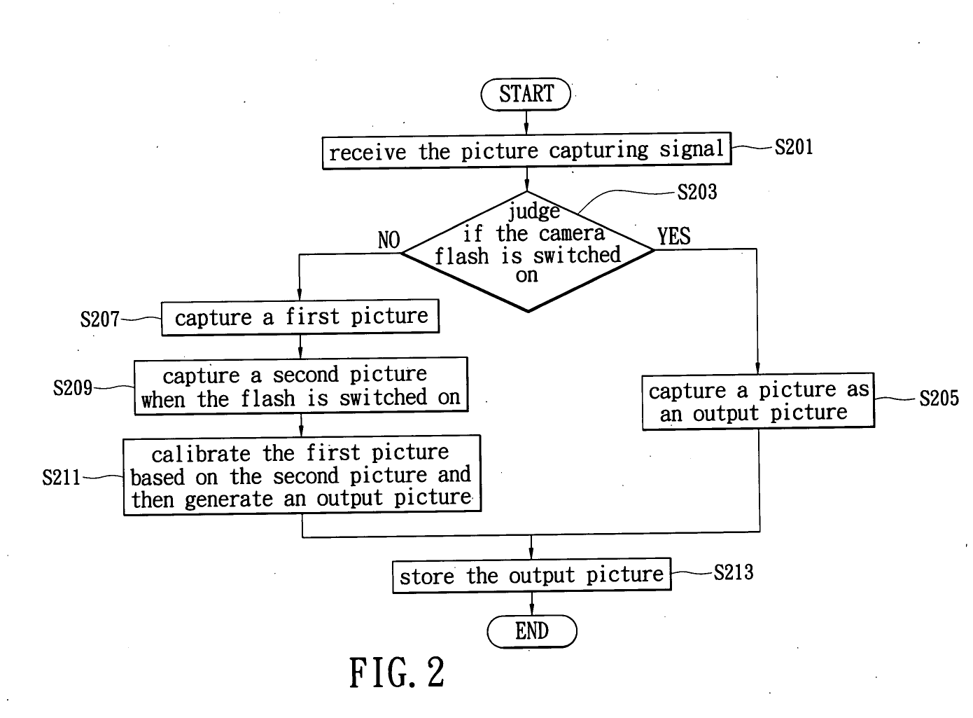

FIG. 2 is a flow chart of a method of obtaining sharp pictures by calibrating blurred pictures according to one embodiment of the invention. The method shown in FIG. 2 is implemented by using the digital camera shown in FIG. 1.

First, the user presses down the release button of the input module 11 to generate a picture capturing signal, and accordingly controls the processing unit 131 to output a picture capturing signal to the picture capturing module 133 which then carries out the picture capturing process after have received the picture capturing signal (Step S201).

The processing unit 131 judges if the camera flash is switched on (Step S203). If yes, then the picture capturing module 133 is controlled to capture a picture as an output picture (Step S205). The output picture is then stored to the memory module 139 (Step S213). If the camera flash is not switched on, then the picture capturing module 133 is controlled to capture a first picture (Step S207). The first picture is then stored into the register 135.

The processing unit 131 controls the flash module 137 to turn on and captures a second picture, and then stores the second picture into the register 135 (Step S209).

Finally, the processing unit 131 carries out a picture capturing process to calibrate the first picture based on the second picture and then outputs a sharper picture (Step S211). The output picture is then stored into the memory module 139 (Step S213).

In one embodiment of the invention, the picture processing calibrates the blurred picture based on the sharp picture if these two pictures are captured at substantially the same conditions at short time intervals.

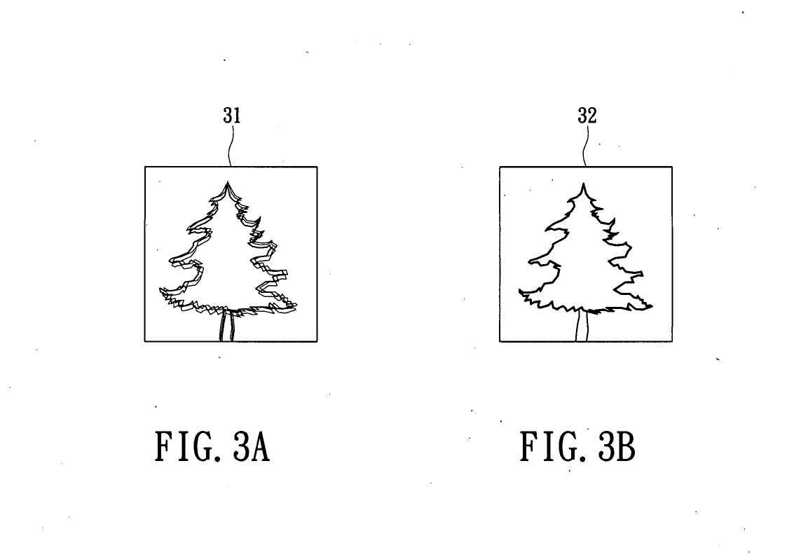

FIG. 3A and FIG. 3B are schematic views of picture calibration according to one embodiment of the invention. The first picture 31 in FIG. 3A is obtained when the flash is not switched on. The second picture 32 in FIG. 3B is obtained when the flash is switched on. These two pictures are captured at short time interval and substantially the same conditions. As shown, the second picture 32 is sharp as the exposure time is shortened and the vibration reduction improves due to the increase in the light intensity is high with detailed profile. The first picture 31 needs longer exposure time to obtain enough light intensity, causing significant vibration which makes the details blurred, particularly the parts along the sharp line of the profile.

In order to reduce the vibration during capturing the first picture 31, the processing unit 131 superimposes the first picture 31 against the second picture 32 and then compares these two pictures. Sharp lines of the second picture 32 define new sharp lines of the first picture 31. When the sharp lines of the first picture 31 has been defined, all blurred parts around the defined sharp lines can be removed by smoothing method or inserting pixels so as to sharpen the first picture. Therefore, a calibrated picture with good sharpness can be output.

It is understood that those skilled in the art realize the embodiment above is one of examples which achieve the picture calibration. DSP in the picture post-processing reduces to an optimal level the blurred sharp lines of the picture generated due to vibration while a photograph is taken. Some dynamic calculations for picture calibration such as frame matching using MAD or MSE can be used in the invention as well.

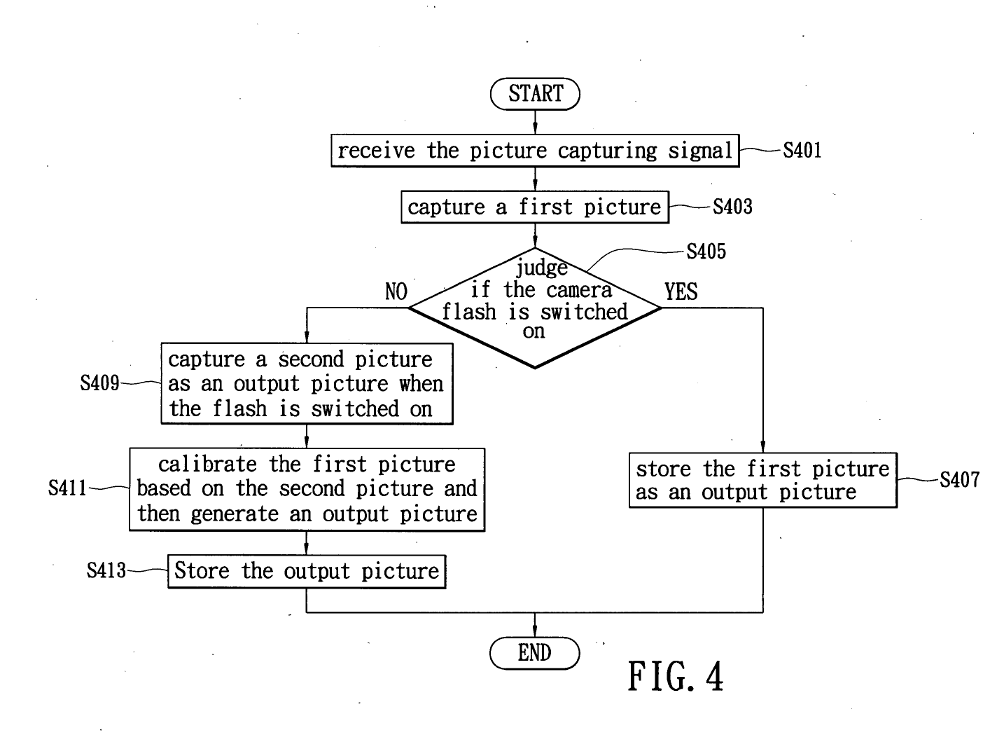

FIG. 4 is a flow chart of a method of obtaining sharp pictures by calibrating blurred pictures captured due to vibration while a photograph is taken according to another embodiment of the invention. Referring to FIG. 1, FIG. 2, FIG. 3A and FIG. 3B, the method of calibrating the blurred pictures includes the following steps.

The user presses down the release button of the input module 11 to generate a picture capturing signal, and accordingly controls the processing unit 131 to output a picture capturing signal to the picture capturing module 133 which then carries out the picture capturing process after have received the picture capturing signal (Step S401). A first picture is captured (Step S403).

The processing unit 131 judges if the camera flash is switched on (Step S405). If YES, then the first picture is stored as an output picture to the memory module 139 (Step S407). If the camera flash is not switched on, then the processing unit 131 stores the first picture to the register 135, controls the flash module 137 to actuate the flash function. The second picture is captured with flash and then stored to the register 137 (Step S409). The flash function is switched off after Step S409.

Finally, the processing unit 131 carries out a picture capturing process to calibrate the first picture based on the second picture and then outputs a sharper picture (Step S411). The output picture is then stored into the memory module 139 (Step S413).

The details regarding to picture processing have been mentioned in the passages of FIG. 3A and FIG. 3B, and therefore will be omitted here. The processing unit determines the number of the pictures to capture and calibrate according to the status of the flash module

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. A method for obtaining sharp pictures by calibrating blurred pictures generated due to vibration while a photograph is taken, the method comprising:
capturing a first picture;
judging if the flash is switched on;
if the first picture is captured when the flash is switched off, then switching on the flash and
capturing a second picture; and
calibrating the first picture based on the second picture.

2. The method of claim 1, further comprising a step of storing the first picture as an output picture if the first picture is captured when the flash is switched on.

3. The method of claim 1, further comprising the following steps before capturing the first picture:
receiving a picture capturing signal which is generated when the user triggers a camera.

4. The method of claim 1, wherein the calibrating step further comprises:
comparing sharp lines in the first picture to those in the second picture;
defining new sharp lines of the first picture by the sharp lines of the second picture; and
removing all blurred parts around the newly defined sharp lines of the first picture.

5. The method of claim 4, wherein the calibrating step further includes the first picture obtained after removing the blurred parts around the newly defined sharp lines is stored as an output picture.

6. The method of claim 5, wherein the camera further comprises:
a picture capturing module, used to capture the first picture and the second picture;
a flash module, including a flash, used to supplement the light intensity;
a register, used to couple with the picture capturing module to temporarily store the captured first and second pictures; and
a processing unit, coupled with the picture capturing module, the flash module and the register to control their operations.

7. The method of claim 6, wherein the camera further comprises:
a memory module, coupled with the processing unit used to store the output picture; and
an input module, coupled with the processing unit to input an external actuation to trigger the camera to generate the picture capturing signal.

8. The method of claim 6, wherein the camera is mobile phone, digital camera or digital video camera.

9. A picture calibration system picture calibration system, installed in a camera, the system comprising:
a picture capturing module, used to capture at least one picture;
a flash module, including a flash, used to supplement the light intensity;
a register, used to couple with the picture capturing module to temporarily store the captured pictures; and
a processing unit, coupled with the picture capturing module, the flash module and the register to control their operations,
wherein the processing unit determines the number of the pictures to capture and calibrate according to the status of the flash module.

10. The method of claim 9, wherein the camera further comprises:
an input module, coupled with the processing unit to receive an external actuation to trigger the camera to generate the picture capturing signal.

11. The method of claim 9, wherein the camera is mobile phone, digital camera or digital video camera.
